(19) United States
(12) Patent Application Publication
(10) Pub. No.: US 2008/0307355 A1
(43) Pub. Date: Dec. 11, 2008

(54) Operating apparatus, image forming apparatus, computer readable recording medium and method for controlling display panel

(75) Inventor: Ryutarou Yokota, Osaka (JP)

Correspondence Address: VON SIMSON & CHIN, 62 WILLIAM STREET, 6TH FLOOR, NEW YORK, NY, 10005, US

(73) Assignee: Kyocera Mita Corporation

(21) Appl. No.: 12/134,624

(22) Filed: Jun. 6, 2008

(30) Foreign Application Priority Data
Jun. 8, 2007 (JP) 2007-153290

(51) Int. Cl. G06F 3/048

(52) U.S. Cl. 715/808

(57) ABSTRACT

An operating apparatus includes a display panel that displays a plural of popup windows with layers and a cancel button used to cancel displaying the popup windows except a window of the highest layer, where the popup windows indicate setting information as the popup windows are shifted relative to each other; an operation unit that processes an operation according to a display status of the display panel; and a control circuit unit that detects that the cancel button has been operated and cancels displaying the popup windows except a window of the highest layer.

### CROSS-REFERENCE TO RELATED APPLICATIONS

This application relates to and claims priority rights from Japanese Patent Application No. 2007-153290, filed on Jun. 8, 2007, the entire disclosure of which is hereby incorporated by reference herein.

### BACKGROUND OF THE INVENTION

1. Field of the Invention

This invention relates to operating apparatus, image forming apparatus, computer readable recording medium and method for controlling display panel.

2. Description of the Related Art

Various kinds of electronic apparatuses have an operating apparatus constituted by a display panel and an operation unit, and the display panel displays a window indicating setting information such as setting status and setting items, and the operation unit processes an operation in relation to the setting information displayed on the display panel.

Such operating apparatuses have an operation unit of touch panel type in which operation buttons unified with a display panel, an operation unit processing an operation when a button displayed on a display panel is chosen by a mouse, etc., an operation unit constituted by a display panel of touch panel type together with an operation button unit such as button switches, or the like.

Further, such a display panel disposed on the operating apparatus sometimes has only a small screen due to a restraint of size of the operating apparatus or an electronic apparatus equipped with it.

In some known display panels, setting items, etc. are classified to groups and a display status can be switched between the groups displayed with layers in order to display the setting items, etc. on the display panel with a small screen due to a restraint of size. In this related technique, to use the small screen efficiently for displaying the layers, a lower layer is displayed over higher layers entirely, that is, on full-screen.

Popup window type is known as another related technique in which for displaying the layers, a window area of each layer is set smaller than a screen of the display panel, and windows with a same area are displayed as a high layer is shifted from a low layer, or a window of a higher layer with smaller area is displayed over windows of lower layers with larger areas.

### SUMMARY OF THE INVENTION

An operating apparatus according to an aspect of the present invention includes a display panel that displays a plural of popup windows with layers and a cancel button used to cancel displaying the popup windows except a window of the highest layer, where the popup windows indicate setting information as the popup windows are shifted relative to each other; an operation unit that processes an operation according to a display status of the display panel; and a control circuit unit that detects that the cancel button has been operated and cancels displaying the popup windows except a window of the highest layer.

A computer readable recording medium according to an aspect of the present invention stores an operating program. The program causes a computer to perform the steps of: determining, based on a display status of a display panel, whether or not an operation has occurred on an operation unit, where the display panel displays popup windows with layers; determining whether or not the operation is an operation of a cancel button common to the layers displayed on the display panel if it is determined that an operation has occurred on the operation unit; and canceling displaying the popup windows except a window of the highest layer if it is determined that the operation that has occurred on the operation unit is an operation of the cancel button.

A method for controlling a display panel according to an aspect of the present invention, includes the steps of: determining, based on a display status of a display panel, whether or not an operation has occurred on an operation unit, where the display panel displays popup windows with layers; determining whether or not the operation is an operation of a cancel button common to the layers displayed on the display panel if it is determined that an operation has occurred on the operation unit; and canceling displaying the popup windows except a window of the highest layer if it is determined that the operation that has occurred on the operation unit is an operation of the cancel button.

These and other objects, features and advantages of the present invention will become more apparent upon reading of the following detailed description along with the accompanied drawings.

### BRIEF DESCRIPTION OF THE DRAWINGS

FIG. 1 shows a front view of an image forming apparatus as an electronic apparatus having an operating apparatus in an embodiment according to an aspect of the present invention;

FIG. 2 shows a block diagram of the operating apparatus in the embodiment according to an aspect of the present invention;

FIG. 3 shows an example of switching a display status by the operating apparatus in the embodiment according to an aspect of the present invention;

FIG. 4 is a flowchart of an example of control by the operating apparatus in the embodiment according to an aspect of the present invention; and

FIG. 5 shows another example of switching a display status by the operating apparatus in the embodiment according to an aspect of the present invention.

### DETAILED DESCRIPTION OF THE PREFERRED EMBODIMENT

Hereinafter, an operating apparatus in an embodiment according to an aspect of the present invention will be explained with reference to drawings.

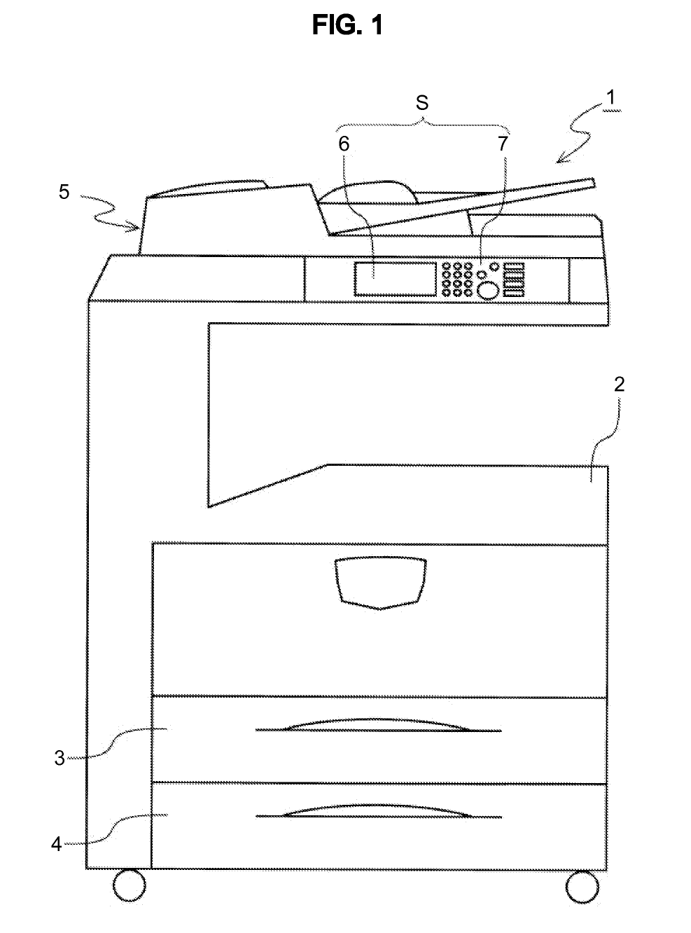

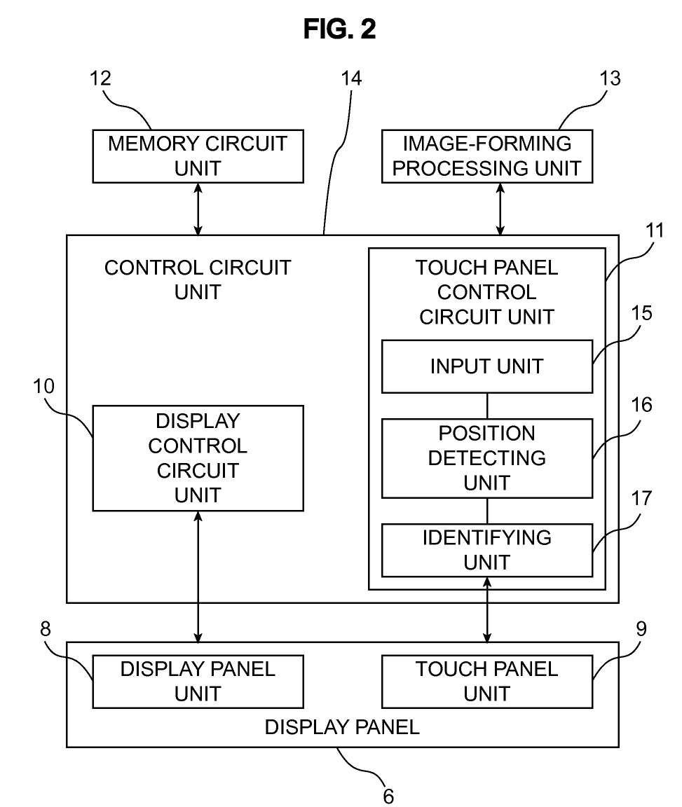

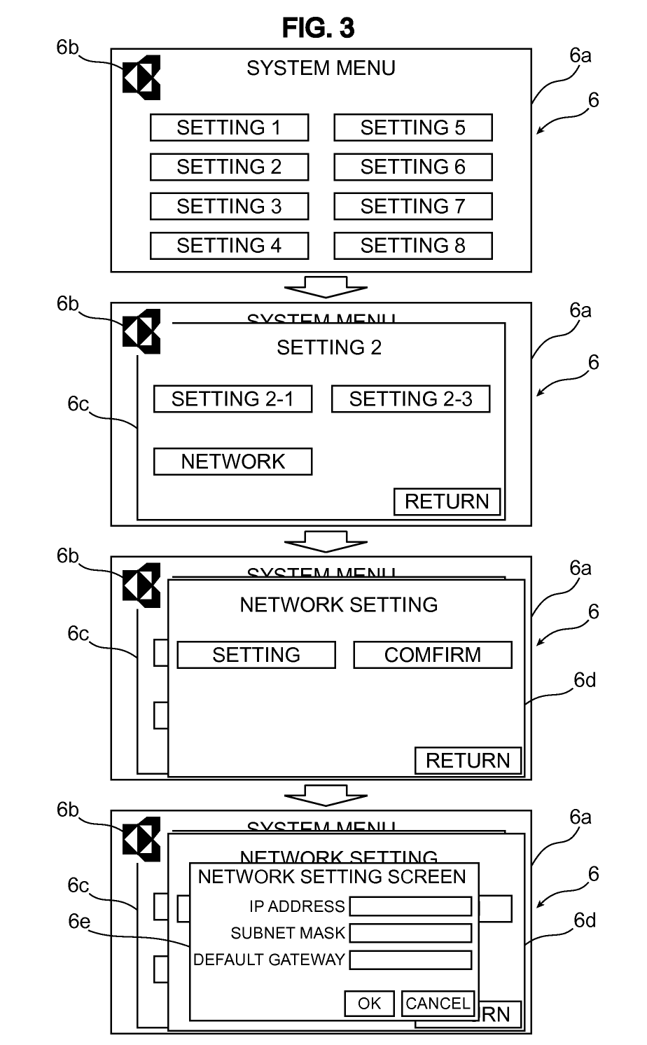

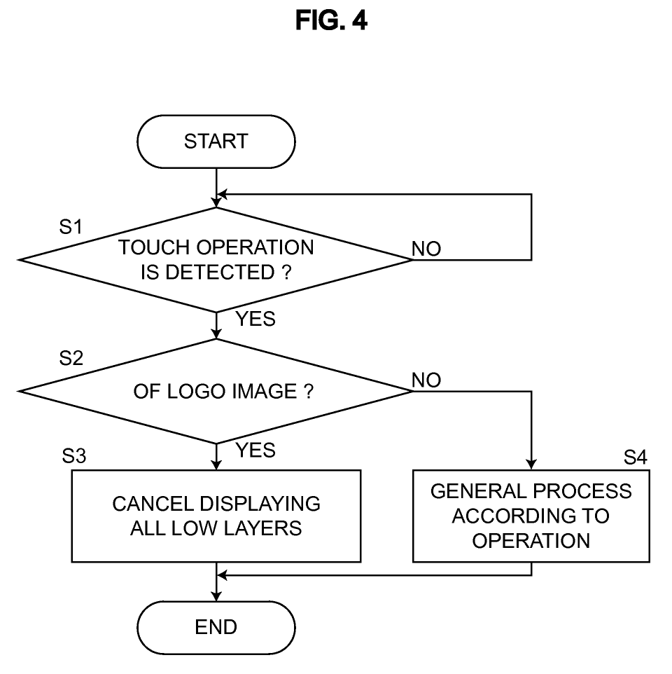

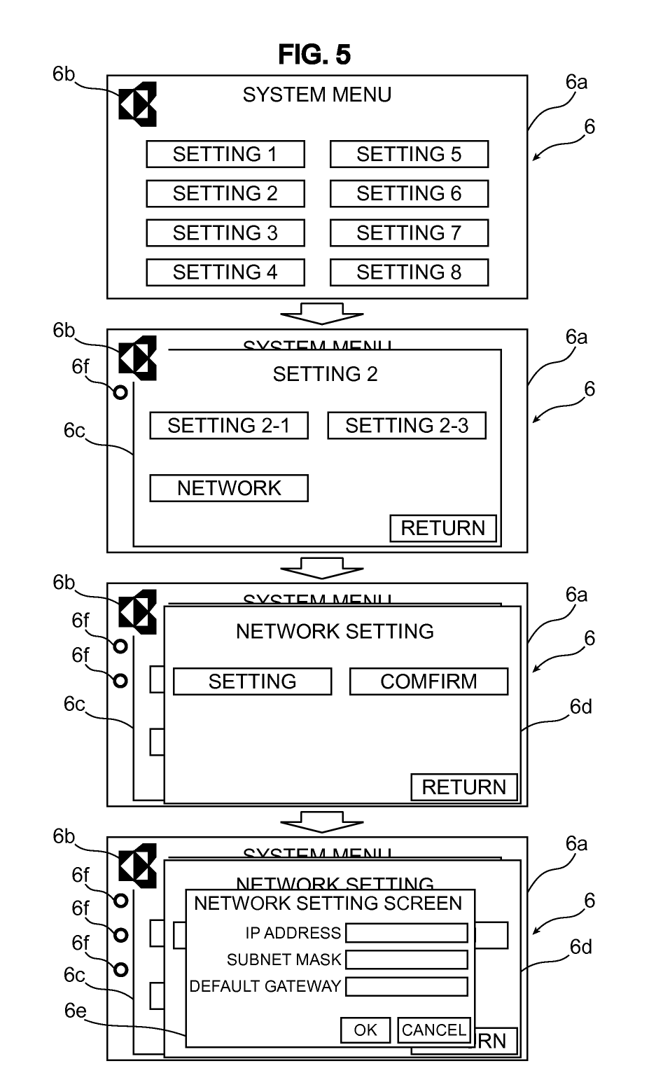

FIG. 1 shows a front view of an image forming apparatus (e.g. multi function printer) as an electronic apparatus having an operating apparatus in an embodiment according to an aspect of the present invention. FIG. 2 shows a block diagram of the operating apparatus in the embodiment according to an aspect of the present invention. FIG. 3 shows an example of switching a display status by the operating apparatus in the embodiment according to an aspect of the present invention. FIG. 4 is a flowchart of an example of control by the operating apparatus in the embodiment according to an aspect of the present invention. FIG. 5 shows another example of switching a display status by the operating apparatus in the embodiment according to an aspect of the present invention.

As shown FIG. 1, an image forming apparatus (e.g. multi function printer) 1 as an electronic apparatus having an operating apparatus in an embodiment according to an aspect of the present invention, has paper feed cassettes 3 and 4 capable of being drawn from the front of an apparatus body 2; an automatic document feeder (ADF) 5 used when a document is scanned on some functions of copier, facsimile machine and scanner; a display panel 6 of touch panel type; and an operation button group 7 such as ten keys. In this embodiment, the display panel 6 and the operation button group 7 constitute an operation unit S that processes both of setting operations and choosing operations on some functions.

The display panel 6 is divided into a display panel unit 8 and a touch panel unit 9 in terms of their functions being a displaying function (by a display driver) and a touch panel function (by a switch driver). The display panel unit 8 handles displaying in the display panel 6 and is controlled by a display control circuit unit 10, and the touch panel unit 9 handles processing operations in the display panel 6 (i.e. operations by touch panel type) and is controlled by a touch panel control circuit unit 11.

A memory circuit unit 12 stores a displaying program and an operating program used for control by the display control circuit unit 10 and the touch panel control circuit unit 11.

Further, the memory circuit unit 12 also stores a controlling program used by a control circuit unit (CPU) 14 and other programs for controlling an image-forming processing unit 13 that performs image-forming processing.

The control circuit unit (CPU) 14 controls image-forming processes including the display control circuit unit 10 and the touch panel control circuit unit 11 overall according to some control programs stored in the memory circuit unit 12 such as ROM or EEPROM. The memory circuit unit 12 stores a controlling program related to display control by the operating apparatus according to an aspect of the present invention, and the control circuit unit 14 includes the display control circuit unit 10 and the touch panel control circuit unit 11, and executes the controlling program. The memory circuit unit 12 and the control circuit unit 14 are constituted by a microcomputer. It should be noted that image data, etc. in image-forming processes are stored temporarily in a storing medium (not shown) such as RAM or HDD other than the memory circuit unit 12.

The touch panel control circuit unit 11 receives touch input by an input unit 15, detects a touched position by a position detecting unit 16, and identifies the meaning and content of operation based on the touched position by an identifying unit 17.

The control circuit unit 14 controls the image-forming processing unit 13 according to the meaning of operation identified by the touch panel control circuit unit 11. The image-forming processing unit 13 performs an image-forming process (e.g. scanning, printing or transmitting an image) according to the control by the unit 14.

On the other hand, the display panel 6 displays a main screen (a system menu) 6a in a highest layer on full-screen as the screen shown at the top in FIG. 3. In the main screen 6a, a cancel button 6b such as icon or logo image is displayed. If one of setting buttons (here, “SETTING 1”, “SETTING 2”, “SETTING 3”, “SETTING 4”, “SETTING 5”, “SETTING 6”, “SETTING 7” and “SETTING 8” for example) displayed on the main screen 6a is chosen with the touch panel system (for example, “SETTING 2”), then a setting screen 6c (“SETTING 2” screen) of a first low layer is displayed over the main screen 6a as the setting screen 6c smaller than the main screen 6a is displayed as a popup window (as the screen shown at the second top in FIG. 3).

In this time, the cancel button 6b can also be used as a cancel button for the setting screen 6c, and is displayed over the layer of the setting screen 6c.

Then, one of setting buttons (here, “SETTING 2-1”, “NETWORK”, “SETTING 2-3” and “RETURN” for example) displayed on the setting screen 6c is chosen with the touch panel system (for example, “NETWORK”), then a setting screen 6d (“NETWORK” screen) of a second low layer is displayed over the setting screen 6c as the setting screen 6d with the almost same area as the setting screen 6c is displayed as a popup window in a position slightly shifted relative to the position of the setting screen 6c (as the screen shown at the third top in FIG.3).

In this time, the cancel button 6b can also be used as a cancel button for the setting screen 6d, and is displayed over the layer of the setting screen 6d.

Moreover, one of setting buttons (here, “SETTING”, “CONFIRM” and “RETURN” for example) displayed on the setting screen 6d is chosen with the touch panel system (for example, “SETTING”), then a setting screen 6e (“NETWORK SETTING” screen) of a lowest layer is displayed over the setting screen 6d as the setting screen 6e is smaller than the screens 6a, 6c and 6d (as the screen of the bottom in FIG. 3).

In this time, the cancel button 6b can also be used as a cancel button for the setting screen 6e, and is displayed over the layer of the setting screen 6e.

As mentioned above, the cancel button 6b is one button shared by a plural of the layers, and is always displayed at the same position.

Therefore, a user can push the cancel button 6b whenever the user wants to cancel the operation, and if the cancel button 6b is pushed with the touch panel system at any time when at least one of the low layers is displayed, then each screen of the layers except the main screen 6a of the highest layer is deleted, and consequently the display status returns to the screen shown at the top in FIG. 3.

In the following part, an example of control by the display control circuit unit 10 and the touch panel control circuit unit 11 will be explained with reference to the flowchart in FIG. 4.

Step 1:

In Step S1, the control circuit unit 14 determines whether or not a touch operation to the touch panel unit 9 has occurred. If it is determined that a touch operation to the touch panel unit 9 has occurred, the unit 14 proceeds to Step S2. If it is determined that any touch operations to the touch panel unit 9 have not occurred, the unit 14 does Step SI again continuously to watch the touch panel unit 9.

Step 2:

In Step S2, the control circuit unit 14 determines whether or not the operation to the touch panel unit 9 was detected at the position on the logo image, that is, whether or not it is an operation of the cancel button 6b. If it is determined that a touch operation of the cancel button 6b has occurred, the unit 14 proceeds to Step S3. If it is determined that any operations of the cancel button 6b have not occurred, the unit 14 proceeds to Step S4.

Step S3:

In Step S3, due to the operation of the cancel button 6b, the control circuit unit 14 causes the display control circuit unit 10 to cancel displaying one or more screens (for example, the setting screens 6c to 6e) except the main screen 6a, and then ends this process.

Step S4:

In Step S4, due to the operation of an operation button other than the cancel button 6b, the control circuit unit 14 causes the touch panel control circuit unit 11 to perform a process corresponding to the operation button, and causes the display control circuit unit 10 to switch the display status.

In this embodiment, where a logo mark image always displayed at the uppermost position is disclosed as the cancel button 6b, for example, as shown in FIG. 5, one or more layer choosing buttons 6f of respective layers may be added and displayed at positions below the cancel button 6b, that is, at positions not overlapped by screens of the low layers. If do so, it is possible to return to a specific higher layer directly chosen by an operation of an optional one of the layer choosing buttons 6f, other than returning the display status layer by layer in terms of operations to “RETURN” buttons in the setting screens 6c and 6d. Further, it is possible to return to a specific higher layer directly chosen by an operation of a part protruded from the lower layers 6d and 6e in one of the setting screens 6c and 6d as well as the operation of the layer choosing button 6f. Consequently, at the time when one of the setting screens 6c and 6d is chosen, displaying the screen(s) of the layer(s) lower than the chosen screen is canceled.

As mentioned above, according to the operating apparatus of the embodiment, on the display panel 6 of touch panel type displaying a menu, etc. with layers, the current screen can be switched to the main screen 6a as the highest layer from any of the low layers by only one operation of the cancel button 6b, and the cancel button 6b is one button shared by the layers and is always displayed at a fixed position, and therefore a user can cancel displaying a plural of unnecessary layers by one-time operation according to his/her intention.

In this embodiment, an operating apparatus of an aspect of the present invention is applied to an image forming apparatus, but it should be noted that it may be applied to a display system in an electronic apparatus that displays popup windows corresponding to operations based on a touch panel system or the like (for example, a video recorder, a guidance terminal apparatus disposed in an airport, etc., an auto teller machine in a bank, a microwave oven, etc.).

Moreover, an operating apparatus of an aspect of the present invention can be applied to any of an operation unit of touch panel type in which operation buttons unified with a display panel, an operation unit processing an operation when a button displayed on a display panel is chosen by a mouse, etc., and an operation unit constituted by a display panel of touch panel type together with an operation button unit such as button switches.

It should be noted that an operating program is provided with a computer readable recording medium such as ROM, hard disc drive, flexible disc, memory card, optic/magnetic disc, or the like. The operating program is read into the memory circuit unit from the computer readable recording medium, and the program is read into the control circuit unit and is executed by a computer in the control circuit unit to provide instructions to members in the operating apparatus and to perform processes for the members.

In view of the embodiments described above, some aspects of the present invention are summarized as follows.

An operating apparatus according to an aspect of the present invention includes a display panel that displays a plural of popup windows with layers and a cancel button used to cancel displaying the popup windows except a window of the highest layer, where the popup windows indicate setting information as the popup windows are shifted relative to each other; an operation unit that processes an operation according to a display status of the display panel; and a control circuit unit that detects that the cancel button has been operated and cancels displaying the popup windows except a window of the highest layer.

Further, it is favorable that the control circuit unit causes the display panel to always display the cancel button at a fixed position on the display panel.

Furthermore, it is favorable that the control circuit unit causes the display panel to display the cancel button independently over one or more layers currently displayed.

Moreover, the control circuit unit may cause the display panel to display a layer choosing button corresponding to each of the layers near the cancel button on the display panel.

Further, an image forming apparatus of an aspect of the present invention includes an image-forming processing unit and an operating apparatus. The operating apparatus has a display panel that displays a plural of popup windows with layers and a cancel button to cancel displaying the popup windows except a window of the highest layer, where the popup windows indicate setting information as the popup windows are shifted relative to each other; an operation unit that processes an operation according to a display status of the display panel; and a control circuit unit that detects that the cancel button has been operated, cancels displaying the popup windows except a window of the highest layer, and controls the image-forming processing unit to cause to form an image according to an operation of the operation unit.

A computer readable recording medium according to an aspect of the present invention stores an operating program. The program causes a computer to perform the steps of: determining, based on a display status of a display panel, whether or not an operation has occurred on an operation unit, where the display panel displays popup windows with layers; determining whether or not the operation is an operation of a cancel button common to the layers displayed on the display panel if it is determined that an operation has occurred on the operation unit; and canceling displaying the popup windows except a window of the highest layer if it is determined that the operation that has occurred on the operation unit is an operation of the cancel button.

A method for controlling a display panel according to an aspect of the present invention, includes the steps of: determining, based on a display status of a display panel, whether or not an operation has occurred on an operation unit, where the display panel displays popup windows with layers; determining whether or not the operation is an operation of a cancel button common to the layers displayed on the display panel if it is determined that an operation has occurred on the operation unit; and canceling displaying the popup windows except a window of the highest layer if it is determined that the operation that has occurred on the operation unit is an operation of the cancel button.

According to an aspect of the present invention, even though a display system of popup window type is used, it is possible to simplify user operations for returning/switching the current displayed screen from one of the low layer to the highest layer at the time when a user wants to cancel the operations or after the operations.

Moreover, according to an aspect of the present invention, it is possible to switch the current displayed screen from one of the low layers to an optional higher layer directly over one or more layers.

What is claimed is:

1. An operating apparatus comprising:
a display panel that displays a plural of popup windows with layers and a cancel button used to cancel displaying the popup windows except a window of the highest layer, the popup windows indicating setting information as the popup windows are shifted relative to each other;
an operation unit that processes an operation according to a display status of the display panel; and
a control circuit unit that detects that the cancel button has been operated and cancels displaying the popup windows except a window of the highest layer.

2. The operating apparatus according to claim 1, wherein the control circuit unit causes the display panel to always display the cancel button at a fixed position on the display panel.

3. The operating apparatus according to claim 1, wherein the control circuit unit causes the display panel to display the cancel button independently over one or more layers currently displayed.

4. The operating apparatus according to claim 1, wherein the control circuit unit causes the display panel to display a layer choosing button corresponding to each of the layers near the cancel button on the display panel.

5. An image forming apparatus comprising:
an image-forming processing unit; and
an operating apparatus having
a display panel that displays a plural of popup windows with layers and a cancel button used to cancel displaying the popup windows except a window of the highest layer, the popup windows indicate setting information as the popup windows are shifted relative to each other;
an operation unit that processes an operation according to a display status of the display panel; and
a control circuit unit that detects that the cancel button has been operated, cancels displaying the popup windows except a window of the highest layer, and controls the image-forming processing unit to cause to form an image according to an operation of the operation unit.

6. A computer readable recording medium storing an operating program, the program causing a computer to perform the steps of:
determining, based on a display status of a display panel, whether or not an operation has occurred on an operation unit, the display panel displays popup windows with layers;
determining whether or not the operation is an operation of a cancel button common to the layers displayed on the display panel if it is determined that an operation has occurred on the operation unit; and
canceling displaying the popup windows except a window of the highest layer if it is determined that the operation that has occurred on the operation unit is an operation of the cancel button.

7. A method for controlling a display panel, comprising the steps of:
determining, based on a display status of a display panel, whether or not an operation has occurred on an operation unit, the display panel displays popup windows with layers;
determining whether or not the operation is an operation of a cancel button common to the layers displayed on the display panel if it is determined that an operation has occurred on the operation unit; and
canceling displaying the popup windows except a window of the highest layer if it is determined that the operation that has occurred on the operation unit is an operation of the cancel button.
